(19) United States
(12) Patent Application Publication
(10) Pub. No.: US 2014/0278285 A1
(43) Pub. Date: Sep. 18, 2014

(54) Method for Quantitative Diagnosis of Cerebrovascular, Neurovascular and Neurodegenerative Diseases via Computation of a CO2 Vasomotor Reactivity Index based on a Nonlinear Predictive Model

(71) Applicants: Vasilis Z. Marmarelis, Palos Verdes Estates, CA (US); Melissa Emily Orme-Marmarelis, Palos Verdes Estates, CA (US); Dae C. Shin, Diamond Bar, CA (US)

(72) Inventors: Vasilis Z. Marmarelis, Palos Verdes Estates, CA (US); Melissa Emily Orme-Marmarelis, Palos Verdes Estates, CA (US); Dae C. Shin, Diamond Bar, CA (US)

(21) Appl. No.: 13/801,426

(22) Filed: Mar. 13, 2013

(51) Int. Cl. G06F 19/00

(52) U.S. Cl. CPC G06F 19/3431
USPC 703/2

(57) ABSTRACT

The present invention relates generally to a method for computer-aided quantitative diagnosis of cerebrovascular and neurodegenerative diseases (such as Alzheimer's, vascular dementia, mild cognitive impairment, transient ischemia, stroke etc.) via a vasomotor reactivity index (VMRI) which is computed on the basis of a computational model of the dynamic nonlinear inter-relationships between beat-to-beat time-series measurements of cerebral blood flow velocity, arterial blood pressure and end-tidal CO2. This model is obtained by means of a method pioneered by the inventors and may incorporate additional physiological measurements from human subjects. Its purpose is to provide useful information to physicians involved in the diagnosis and treatment of cerebrovascular and neurodegenerative diseases with a significant neurovascular component by offering quantitative means of assessment of the effects of the disease or medication on cerebral vasomotor reactivity. Initial results from clinical data have corroborated the diagnostic potential of this approach.

### CROSS REFERENCE TO RELATED APPLICATION

This application is related to and claims the benefit of the filing dates of the following U.S. provisional application: Ser. No. 61/609,964 filed Mar. 13, 2012, entitled “Quantitative Diagnosis of Cerebrovascular and Neurodegenerative Diseases via Model-based Computation of a Cerebral Vasomotor Reactivity Index”, the contents of which are incorporated herein by reference.

### BACKGROUND OF THE INVENTION

1. Field of Invention

The present invention relates generally to a method for computer-aided quantitative diagnosis of cerebrovascular, neurovascular and neurodegenerative diseases (such as Alzheimer's, dementia, mild cognitive impairment, stroke, cerebral angiopathy or atrophy, ischemia, stroke, subcortical infarctions, executive dysfunction due to hypertension etc.) via a CO2 vasomotor reactivity index (VMRI) which is computed on the basis of a predictive model of the dynamic nonlinear inter-relationships between beat-to-beat time-series measurements of cerebral blood flow velocity, arterial blood pressure and end-tidal CO2 measured non-invasively. This model may incorporate additional physiological time-series measurements (e.g. oxygen saturation, respiratory rate, tidal volume, autonomic activity or heart-rate variability) that can be obtained with non-invasive, minimally-invasive or invasive methods from human subjects. The purpose of the predictive model is to provide reliable quantitative means for the computation of appropriate “physiomarkers” (i.e. indices based on the physiology of the subject system that serve as markers of specific pathological states) that quantify the cerebral vasomotor reactivity of each subject through analysis of time-series hemodynamic data. These physiomarkers are expected to have diagnostic utility by providing valuable information about the patho-physiological state of patients to physicians who are involved in the diagnosis and treatment of cerebrovascular, neurovascular and neurodegenerative diseases. These physiomarkers are also expected to offer quantitative means for the assessment of the effects of treatments and medications upon the progress of the disease by monitoring the state of cerebral vasomotor reactivity.

The invention is a computer-aided diagnostic method that is based on advanced mathematical/computational predictive models of the dynamic relationships among time-series data of physiological measurements collected in a clinical setting. These predictive nonlinear models are obtained by means of a methodology pioneered by the inventors. Initial results from clinical data corroborate the diagnostic potential of this approach.

2. Prior Art

There is mounting evidence that Alzheimer's disease (AD) is associated with impairment of cerebral vasomotor reactivity [cited publications 1-20]. Such indications are evident even in the early stages of AD and found in other cerebrovascular and neurodegenerative diseases, such as Mild Cognitive Impairment (MCI) due to hypertension or other conditions. To utilize this fact for improved diagnosis and treatment monitoring of early-stage AD or other applicable diseases, we need a reliable, sensitive, quantitative and objective measure of cerebral vasomotor reactivity that can be obtained safely, consistently, reliably and comfortably in a clinical setting, even from minimally cooperative and elderly subjects. This can be useful for the diagnosis and treatment monitoring of a host of cerebrovascular, neurovascular and neurodegenerative diseases (e.g. vascular dementia, mild cognitive impairment, cerebral angiopathy or atrophy, cerebral ischemia or ischemic attack, stroke, executive dysfunction due to hypertension, subcortical infarctions, diabetes etc.) where cerebral vasomotor reactivity is a significant physiological component. The realistic prospect of achieving improved diagnosis of early-stage AD by means of a reliable, sensitive, quantitative and objective measure of cerebral vasomotor reactivity that can be obtained safely in a clinical setting has important implications for the management of AD and other diseases with a significant neurovascular component. The present invention describes a method that yields such a measure of cerebral vasomotor reactivity in a clinical setting, which is based on a nonlinear predictive model of the dynamics of this process in the context of cerebral flow autoregulation (CFA) obtained through analysis of time-series beat-to-beat hemodynamic data.

The study of CFA in cerebral hemodynamics has revealed the presence of multiple physiological control mechanisms that maintain variations of cerebral blood flow within narrow bounds for physiological changes of perfusion pressure in healthy humans [cited publications 21-44]. Variations in blood perfusion pressure and CO2 tension are viewed as key factors affecting variations in cerebral blood flow. Because of its vital importance, CFA has received considerable attention and many studies have sought to advance our understanding of the underlying physiological mechanisms. Quantification of these physiological mechanisms has been pursued with computational models that describe typically the quantitative relationship between beat-to-beat measurements of arterial blood pressure and cerebral blood flow for various levels of CO2 tension. The requisite data for the estimation of this model can be collected non-invasively, safely and comfortably in a clinical setting. This modeling task is not trivial and has been confounded to date by the many complexities of this system. We have recently developed a model that provides a fairly complete description of the dynamic nonlinear characteristics of CFA, including CO2 vasomotor reactivity, and has demonstrated excellent predictive capability relative to existing alternatives [cited publication 45]. To achieve this formidable goal, the employed modeling methodology utilizes the novel concept of Principal Dynamic Modes (PDMS) that has been advanced by our group and demonstrated to be effective in several physiological domains to date [cited publications 45-46].

This invention provides a reliable, sensitive, quantitative and objective measure of cerebral vasomotor reactivity that is based on a predictive nonlinear model of the dynamics of this process in the context of CFA. One such measure derived from the obtained model is a vasomotor reactivity index (VMRI) that has been shown to separate AD patients from control subjects [cited publication 45]. The model is obtained by processing beat-to-beat measurements of mean arterial blood pressure, mean cerebral blood flow velocity in the middle cerebral artery and end-tidal CO2 that are collected non-invasively from human subjects in a clinical setting. The model utilizes the concept of Principal Dynamic Modes (PDMS) in the context of an advanced nonlinear modeling technique and allows computation of the VMRI of each subject via data-based model simulations in a practical manner [cited publication 45].

Prior art in terms of issued patents and patent applications in this subject area has been focused either on hemodynamic autoregulation to pressure changes instead of CO2 vasomotor reactivity, which is the subject of the present invention, or on methods for continuous measurements of hemodynamic data. A good example of the former category is the recent U.S. Pat. No. 8,062,224 B2 (November 2011) by Ragauskas et al. entitled “Method and apparatus for non-invasive continuous monitoring of cerebrovascular autoregulation state, where the phase shift between the intracranial blood volume respiratory waves and the lung volume respiratory waves is used to characterize the cerebrovascular autoregulatory state of each subject. Good examples of the latter category are the US patent application No. 0049060 A1 (February 2010) by Schecter entitled “Implantable hemodynamic monitor and methods for use therewith”, and the U.S. Pat. No. 6,875,176 B2 (April 2005) by Mourad et al. entitled “Systems and methods for making noninvasive physiological assessments”, which uses tissue displacement measurements with focused ultrasound to monitor intracranial pressure, arterial blood pressure and cerebrovascular autoregulation). Several other US patents are listed below but none is overlapping with the present invention or is directly related to it.

### BRIEF SUMMARY OF THE INVENTION

The invention generally relates to a method for computer-aided quantitative diagnosis of cerebrovascular, neurovascular and neurodegenerative diseases via a vasomotor reactivity index (VMRI) which is acquired via computations based on an advanced mathematical and computational model of the dynamic nonlinear relationships among beat-to-beat time-series measurements of mean cerebral blood flow velocity, mean arterial blood pressure and blood CO2 tension (represented by the surrogate measurement of end-tidal CO2) obtained by non-invasive means in human subjects within a clinical setting. Other physiological variables that are relevant to cerebral hemodynamics and can be measured by a variety of non-invasive, minimally-invasive or invasive means in human subjects and may be incorporated in the model (e.g. oxygen saturation, heart-rate variability, respiratory sinus arrhythmia etc.). The employed models for the computation of the VMRI are obtained from the data of each subject through a methodology pioneered by the inventors for the process of cerebral flow autoregulation that includes vasomotor reactivity [cited publication 45]. The subject-specific models are used to compute the predicted response of cerebral flow velocity in each subject to a pulse increase or decrease of blood CO2 tension (represented in the model by its surrogate end-tidal CO2). The model-predicted responses of cerebral flow velocity (typically in the middle cerebral artery) are then used to compute the VMRI as the normalized average over 30 sec (which has been found to be the maximum time that the effects of CO2 change on cerebral flow velocity may last). Because this physiological system (and the corresponding model) is nonlinear, we favor using the difference of the computed normalized averages for a pulse increase and a pulse decrease of CO2 (taken typically to be equal to one standard deviation of the respective recorded end-tidal CO2 data in each subject). The resulting index is a measure of the CO2 vasomotor reactivity of the monitored blood vessel (typically the middle cerebral artery), expressed in units of cm/sec/mmHg, and may serve as a reliable and sensitive “physiomarker” (i.e. depictive of the physiology of cerebral hemodynamics) to assist the diagnosis and treatment monitoring of cerebrovascular, neurovascular and neurodegenerative diseases in a clinical setting.

There have thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object of the present invention is to provide a method for the computation of a quantitative index of clinical diagnostic value, describing the cerebral CO2 vasomotor reactivity that is based on a dynamic nonlinear model describing the inter-relationships among time-series measurements of cerebral blood flow velocity, arterial blood pressure and CO2 tension.

Another object of the present invention is to provide a method for the computation of a quantitative index of clinical diagnostic value, describing the cerebral flow autoregulation in response to changes in blood pressure that is based on a dynamic nonlinear model describing the inter-relationships among time-series measurements of cerebral blood flow velocity, arterial blood pressure and CO2 tension.

Another object of the present invention is to provide a method for the computation of quantitative indices of clinical diagnostic value, based on dynamic nonlinear models describing the inter-relationships among time-series measurements of cerebral blood flow velocity, arterial blood pressure, blood gases and other physiological variables, that may be useful in clinical diagnosis and treatment decisions, as well as monitoring of the effects of treatments or other conditions influencing the cerebral vasculature, the neurovascular state, the metabolic function or the neurological function of a human subject.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1: The pre-processed (de-meaned and de-trended) time-series data of beat-to-beat measurements of mean blood flow velocity in the middle cerebral artery (top row), mean arterial blood pressure (middle row), and end-tidal CO2 (bottom row) over 6 min.

FIG. 2: Block-diagram of the PDM-based model of cerebral hemodynamics employed by the present invention, having three PDMs for each input, x₁: mean arterial blood pressure, and x₂: end-tidal CO2. The output u_{j,m} of the j-th PDM for the m-th input (m=1 or 2) is the convolution of the PDM with the respective input. The ANFs are usually taken to be cubic polynomials: z_{j,m}=a_{1,j,m}u_{j,m}+a_{2,j,m}u_{j,m}²+a_{3,j,m}u_{j,m}³. The selected cross-terms, {c_{i,j}u_{i,1}(n)u_{j,2}(n)}, have significant correlation with the output variable y: mean cerebral blood flow velocity. The latter is formed as the sum of all ANF output components {z_{j,m}}, the selected significant cross-terms and a constant value c₀.

FIG. 3: Illustrative sets of three PDMs for the mean arterial blood pressure input (FIGS. 3a and 3b, time-domain and frequency-domain representation respectively) and end-tidal CO2 input (FIGS. 3c and 3d, time-domain and frequency-domain representation respectively) of the PDM-based model of cerebral hemodynamics (see FIG. 2) obtained from 16 control subjects. The units in the ordinate axis of the time-domain representations are: cm/sec²/mmHg.

FIG. 4: Illustrative example of the average ANFs corresponding to the two sets of PDMs of FIG. 3 in 16 control subjects: ANFs corresponding to the mean arterial blood pressure input (top) and to the end-tidal CO2 input (bottom).

FIG. 5: Illustrative example of the model-predicted mean cerebral blood flow velocity (MCBFV) in response to a 30-sec pulse change of the end-tidal CO2 (ETCO2) input, while the mean arterial blood pressure input remains at baseline, for a control subject (5a) and an Alzheimer's patient (5b). The pulse amplitude is set to +/−1 standard deviation of the respective ETCO2 data. The impaired CO2 vasomotor reactivity of the patient is evident by the fact that the MCBFV response does not follow the ETCO2 pulse change. The computed VMRI is the difference of the averages of the MCBFV responses over 30 sec (positive pulse response minus negative pulse response) normalized by the respective input pulse amplitude. The units of the VMRI are: cm/sec/mmHg.

FIG. 6: Block-diagram of the closed-loop PDM-based model of cerebral hemodynamics, where F(t) denotes the mean cerebral blood flow velocity data, P(t) denotes the mean arterial blood pressure data, C(t) denotes the end-tidal CO2 data, Fₘ(t) denotes the model prediction of blood flow velocity by component A, and Pₘ(t) denotes the model prediction of blood pressure by component B. The signals F_{d}(t) and P_{d}(t) are the residuals of the respective model predictions for A and B, and they are viewed as systemic (extra-loop) cerebral blood flow and pressure “disturbances” driving this closed-loop physiological system. This closed-loop model configuration can be used to compute the VMRI on the basis of the predicted intra-loop flow velocity for a pulse change of the CO2 variable.

Table 1: Computed model-based VMRI values in cm/sec/mmHg for 8 Control Subjects (CS: left) and 8 Alzheimer's Patients (AP: right). A small VMRI value (typically<2 cm/sec/mmHg) implies CO2 vasomotor reactivity impairment.

### DETAILED DESCRIPTION OF THE INVENTION

### A. Overview

The modeling methodology required by the invention utilizes the key concept of Principal Dynamic Modes (PDM) which has been pioneered by the inventors and has been elaborated in a recent monograph [46]. While one embodiment is illustrated in this application, many variations exist that will not limit the general applicability of the method or compromise the integrity of the requisite data. The method comprises the following computational steps:

### B. Estimation of the PDMs of Each Subject

The PDMs of each subject are estimated from the collected beat-to-beat time-series data of mean cerebral blood flow velocity, mean arterial blood pressure and end-tidal CO2 (obtained by a variety of non-invasive methods from human subjects in a clinical setting) over several minutes. The beat-to-beat measurements are pre-processed to remove artifacts and they are re-sampled evenly over time, typically at 2 samples per second. Very low frequency trends or cycles are removed prior to processing of the time-series data to obtain a dual-input dynamic nonlinear Volterra model, following the methodology pioneered by the inventors [cited publications 45-46]. Typically, two inputs are used: one representing blood CO2 tension through its surrogate end-tidal CO2 measurements (ETCO2) and the other being the measurements of beat-to-beat mean arterial blood pressure (MABP). The output variable is the beat-to-beat measurements of mean cerebral blood flow velocity in the middle cerebral artery. An illustrative example of such time-series data is shown in FIG. 1, where the variations of mean cerebral blood flow velocity are represented by transcranial Doppler measurements in the middle cerebral artery.

In the presented embodiment, the modeling task commences with the estimation of a 2^{nd} order Volterra model of this dual-input system using Laguerre expansions of the kernels with 5 basis functions for the MABP (input #1) and 3 basis functions for the ETCO2 (input #2). This results in 45 free parameters (including a constant baseline term) for the dual-input 2^{nd} order Volterra model, which can be adequately supported (in terms of estimation accuracy) by a minimum of 4 min of time-series data. Typically, 6 min of time-series data are collected and analyzed. The proposed procedure estimates the kernels of the dual-input 2nd order Volterra model that has the form [46]:

$$y ( t ) = {k}_{0} + {\int }_{0}^{∞} {k}_{p} ( τ ) p ( t - τ ) d τ + {\int }_{0}^{∞} {k}_{x} ( τ ) x ( t - τ ) d τ + \int {\int }_{0}^{∞} {k}_{pp} ( {τ}_{1} , {τ}_{2} ) p ( t - {τ}_{1} ) p ( t - {τ}_{2} ) d {τ}_{1} d {τ}_{2} + \int {\int }_{0}^{∞} {k}_{xx} ( {τ}_{1} , {τ}_{2} ) x ( t - {τ}_{1} ) x ( t - {τ}_{2} ) d {τ}_{1} d {τ}_{2} + \int {\int }_{0}^{∞} {k}_{px} ( {τ}_{1} , {τ}_{2} ) p ( t - {τ}_{1} ) x ( t - {τ}_{2} ) d {τ}_{1} d {τ}_{2} + ɛ ( t ) \qquad ( 1 )$$

where p(t) denotes the MABP input, x(t) denotes the ETCO2 input and y(t) denotes the mean cerebral blood flow velocity (MCBFV) output. The modeling task involves the estimation of the unknown Volterra kernels of the model {kₚ, kₓ, kₚₚ, kₓₓ, kₚₓ} from given input-output data p(t), x(t) and y(t). This task is facilitated immensely by Laguerre expansions of the kernels:

$${k}_{p , … p , r} ( {τ}_{1} , … , {τ}_{r} ) = {\sum }_{{j}_{1} = 1}^{L} … {\sum }_{{j}_{r} = 1}^{L} {a}_{r} ( {j}_{1} , … , {j}_{r} ) {b}_{j 1} ( {τ}_{1} ) … {b}_{{j}_{r}} ( {τ}_{r} ) \\ {k}_{x , … x , r} ( {τ}_{1} , … , {τ}_{r} ) = {\sum }_{{j}_{1} = 1}^{L} … {\sum }_{{j}_{r} = 1}^{L} {c}_{r} ( {j}_{1} , … , {j}_{r} ) {b}_{j 1} ( {τ}_{1} ) … {b}_{{j}_{r}} ( {τ}_{r} ) \qquad ( 2 )$$

where {bⱼ(τ)} denote the orthogonal Laguerre function basis. Other bases can be used as well. Such kernel expansion yields the following nonlinear input-output relation which involves linearly the Laguerre expansion coefficients {aᵣ} and {cᵣ}:

$$y ( t ) = {c}_{0} + {\sum }_{r = 1}^{Q} {\sum }_{{j}_{1} = 1}^{L} … {\sum }_{{j}_{r} = 1}^{{j}_{r - 1}} {a}_{r} ( {j}_{1} , … , {j}_{r} ) {v}_{j 1} ( {τ}_{1} ) … {v}_{{j}_{r}} ( t ) + {\sum }_{r = 1}^{Q} {\sum }_{{j}_{1} = 1}^{L} … {\sum }_{{j}_{r} = 1}^{{j}_{r - 1}} {c}_{r} ( {j}_{1} , … , {j}_{r} ) {z}_{j 1} ( {τ}_{1} ) … {z}_{{j}_{r}} ( t ) + ɛ ( t ) \qquad ( 3 )$$

where the signals vⱼ(t) and zⱼ(t) are the convolutions of the Laguerre basis function bⱼ with the respective input, and ε(t) denotes possible measurement or modeling errors. The fact that the Laguerre expansion coefficients enter linearly in the nonlinear Volterra model of Equation (3) allows their estimation via least-squares regression (a simple, robust and stable numerical procedure). Having estimated the Laguerre expansion coefficients, we can construct the Volterra kernel estimates using Equation (2) and compute the model prediction for any given input using Equation (1) or (3). This procedure applies to higher order Volterra models as well.

The introduction of the concept of Principal Dynamic Modes (PDMs) has allowed the practical estimation of nonlinear models of higher order as in the subject application. Briefly stated, the use of PDMs is an efficient basis and allows us to write the output Equation (3) as:

$$y ( t ) = {c}_{0} + {\sum }_{h = 1}^{H} {f}_{h} [ {τ }_{{l}_{h}} ( t ) ] + {\sum }_{m = 1}^{M} {f}_{m} [ {u}_{m} ( t ) ] + CrossTerms + R ( t ) \qquad ( 4 )$$

where {uₙ(t)} and {uₘ(t)} are the PDM outputs (i.e. convolutions of the input with the respective PDM) for the MABP and ETCO2 inputs, respectively, and {fₙ[uₙ]}, {fₘ[uₘ]} are the static nonlinearities associated with each PDM, termed Associated Nonlinear Functions (ANFs). The ANFs are typically given polynomial form (cubic in this application). The “Cross Terms” in Equation (4) are pair products of {uₕ} and {uₘ} that have significant correlation with the output. The coefficients of the selected Cross-Terms are estimated, along with c₀ and the coefficients of the (cubic) ANFs via least-squares regression of Equation (4). The computation of the PDMs from the kernel estimates employs Singular Value Decomposition (SVD) of a rectangular matrix composed of the 1st order kernel estimates (as column vectors) and the 2nd order self-kernel estimates as block sub-matrices, weighted by the root-mean-square value of the respective input. A block-diagram of the PDM-based model of the dual input system of cerebral hemodynamics is shown in FIG. 2.

### C. Computation of the Global PDMs of the Control Group

Following the estimation of the PDMs for each subject in the reference group of control subjects, we compute the “global PDMs” for each input as the most significant “singular vectors” (corresponding to the largest “singular values”) resulting from SVD analysis of the rectangular matrix containing the PDMs for all subjects in the reference group weighted by the respective singular values. It is important to note that the waveforms of the global PDMs were not affected significantly when different sets of control subjects were randomly selected for the reference group. This fact corroborates the premise of the existence of global PDMs for this system, which corroborates the proposition that the PDM-based model is generalizable (i.e. applicable to all subjects) and, therefore, potentially useful for diagnostic purposes. An illustrative example of obtained global PDMs following the outlined procedure for a set of 16 control subjects is given in FIG. 3.

### D. Estimation of the Associated Nonlinear Functions of Each Subject

To complete the development of the PDM-based nonlinear model of a subject, we must further estimate the Associated Nonlinear Function (ANF) of this subject for each global PDM, which is a static nonlinearity applied to the convolution of the input signal with the respective global PDM. The ANFs are subject-specific and contain the differentiating information among subjects that is valuable for clinical diagnosis. Completion of the PDM-based model also requires the estimation of the coefficients of the cross-terms in the model of Equation (4) that are composed of pair products of PDM outputs. The cross-terms account for the inter-modulation effects between the two inputs as they affect the output. The model output prediction is composed of the sum of all ANF outputs and cross-terms, along with a constant baseline value, as indicated in the block-diagram of FIG. 2. The coefficients of the six cubic ANFs (one for each of the six PDMs) and the significant cross-terms are estimated via least-squares fitting of the input-output data according to Equation (4). The estimated coefficients of the ANFs and the cross-terms are distinct for each subject and can be used to quantify uniquely its cerebral hemodynamics, offering a potential diagnostic tool for AD (or other diseases with a cerebrovascular component). It was found that cubic ANFs are adequate for this system. An illustrative example of the ANFs obtained for the two sets of three global PDMs for the MABP and ETCO2 inputs in a control subject are shown in FIG. 4.

### E. Computation of the CO2 Vasomotor Reactivity Index (VMRI)

Considerable inter-subject variability was observed in the form of the ANFs corresponding to the two sets of global PDMs for the two inputs of this model. However, the critical finding, relevant to the utility of this invention, is that this variability remained within well-defined bounds for each of the two groups of control subjects (CS) and AD patients (AP), and furthermore the functional characteristics of these two groups (defined largely by the respective ANFs) were rather distinct and allowed clear delineation of the two groups. To quantify this important fact of significant vasomotor reactivity differences between the two groups in a practical manner that can have clinical utility, we propose the use of a scalar vasomotor reactivity index (VMRI) that is computed as the difference of the time-averages of the model-predicted mean cerebral blood flow velocity in response to pulse changes in the end-tidal CO2 input over 30 sec (positive pulse response minus negative pulse response) normalized by the respective input pulse amplitude, while the arterial pressure input is kept at baseline. The VMRI is expressed in units of cm/sec/mmHg. An illustrative example of the model-predicted mean cerebral flow responses to pulse changes in CO2 for a control subject and an Alzheimer's patient is given in FIG. 5.

### F. Closed-Loop Model Configuration

A model of cerebral hemodynamics that accounts for the mutual interdependence of blood pressure and flow, as dictated by the Navier-Stokes equation governing fluid dynamics, can be constructed in a closed-loop configuration that includes two input-output model components, A and B, as depicted in FIG. 6. Model component A has inputs of pressure and CO2, and output of flow velocity (as in the aforementioned model), while model component B has inputs of flow velocity and CO2, and output of pressure. This closed-loop model is driven by two external “disturbance” signals of flow velocity and pressure, which are the computed residuals of the model prediction by the input-output models A and B, respectively. This closed-loop model configuration can be used to compute the VMRI on the basis of the predicted intra-loop flow velocity for a pulse change of the CO2 variable. From FIG. 6, we can derive the closed-loop equations:

$$\begin{matrix}\begin{matrix}F ( t ) = A \{ P , C \} + {F}_{d} ( t ) \\ = A \{ B [ F , C ] + {P}_{d} ( t ) , C \} + {F}_{d} ( t )\end{matrix} & ( 5 ) \\ \begin{matrix}P ( t ) = B \{ F , C \} + {P}_{d} ( t ) \\ = B \{ A [ P , C ] + {F}_{d} ( t ) , C \} + {P}_{d} ( t )\end{matrix} & ( 6 )\end{matrix}$$

which are nonlinear stochastic integral equations. For each A and B model, we have:

F(t)=F₀+Σfᵢ^{PF}└uᵢ^{PF}(t)┘+Σfⱼ^{CF}└uⱼ^{CF}(t)┘+Σc_{k,l}^{PC}uₖ^{PF}(t)uₗ^{CF}(t)+F_{d}(t) (7)

P(t)=P₀+Σfᵢ^{FP}└uᵢ^{FP}(t)┘+Σfⱼ^{CP}└uⱼ^{CP}(t)┘+Σc_{k,l}^{FC}uₖ^{FP}(t)uₗ^{CP}(t)+P_{d}(t) (8)

where the signals u(t) are convolutions of the input signals with the PDMs, the functions ƒ[·] are polynomials, and F₀, P₀ are the baseline values of pressure and flow velocity respectively (i.e. their values when there are no systemic disturbances). Simulations of this closed-loop model for pulse changes of CO2 allow computation of the VMRI as described earlier.

### G. Connections of Main Elements and Sub-Elements of Invention

The elements of this invention are the sequential methodological and computational steps that capture the dynamic nonlinear relationship governing cerfebral hemodynamics in healthy subjects and AD patients or patients with other cerebrovascular and neuro-degenerative diseases with a significant neurovascular component.

### Alternative Embodiments of Invention

The invention can be implemented in various ways, different from the presented preferred embodiment. For instance, different kernel expansion bases (other than Laguerre) can be used for the estimation of the initial Volterra model, which may be of various orders (other than second) and with multiple inputs (not the two used in the preferred embodiment). Likewise, the estimation of the subject PDMs can be accomplished with alternate methods (e.g. using iterative procedures like the Laguerre-Volterra Network [46]) and the computation of the global PDMs can be performed with methods other than SVD. The utilized model may not be based on PDMs. Most importantly, the model-based definition and computation of the appropriate VMRI used for diagnostic purposes may take various forms of quantification of vasomotor reactivity, other than the one described in the preferred embodiment.

Operation of Preferred Embodiment

The presented procedural steps of the invented method must be performed in sequence and in adherence to the underlying technical requirements. The resulting VMRI is used for quantitative clinical diagnosis and treatment monitoring in AD or other cerebrovascular and neurodegenerative diseases with a significant neurovascular component.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

### REFERENCES CITED

U.S. PATENT DOCUMENTS

| | | | |
|---|---|---|---|
| 1 | 8,062,224 B2 | November 2011 | Ragauskas et al. |
| 2 | 0,049,060 A1 | February 2010 | Schecter |
| 3 | 7,198,602 B2 | April 2007 | Eide |
| 4 | 6,875,176 B2 | April 2005 | Mourad et al. |
| 5 | 0,230,105 A1 | November 2004 | Geva et al. |
| 6 | 6,117,089 A | September 2000 | Sinha |
| 7 | 5,987,351 A | November 1999 | Chance |
| 8 | 5,951,477 A | September 1999 | Ragauskas et al. |
| 9 | 5,951,476 A | September 1999 | Beach |
| 10 | 5,919,144 A | July 1999 | Bridger et al. |
| 11 | 5,842,990 A | December 1998 | Kraske |
| 12 | 5,840,018 A | November 1998 | Michaeli |
| 13 | 5,817,018 A | October 1998 | Ohtomo |
| 14 | 5,785,656 A | July 1998 | Chiabrera et al. |
| 15 | 5,617,873 A | April 1997 | Yost et al. |
| 16 | 5,579,774 | December 1996 | Miller et al. |
| 17 | 5,514,146 A | May 1996 | Lam et al. |

### OTHER CITED PUBLICATIONS

1. Sellke F W, S Seshadri, H C Chui, R T Higashida, R Lindquist, P M Nilsson, G C Roman, R C Petersen, J A Schneider, C Tzourio, D K Arnett, D Bennett, C ladecola, U Launer, S Laurent, O L Lopez, D Nyenhuis, P B Gorelick, A Scuteri, S E Black, C DeCarli, S M Greenberg (2011). Vascular Contributions to Cognitive Impairment and Dementia: A Statement for Healthcare Professionals from the AHA/ASA. Stroke 42 (9): 2672-2713.
2. Silvestrini M, P Pasqualetti, R Baruffaldi, M Bartolini, Y Handouk, M Matteis, F Moffa, L Provinciali and F Vernieri (2006). Cerebrovascular reactivity and cognitive decline in patients with Alzheimer's disease. Stroke 37:1010-1015.
3. de la Torre J C (2002). Alzheimer disease as a vascular disorder. Nosological evidence. Stroke 33:1152-1162.
4. Iadecola C (2003). Cerebrovascular effects of amyloid-beta peptides: mechanisms and implications for Alzheimer's dementia. Cell Mol Neurobiol 23:681-9.
5. Iadecola C and Gorelick P B (2003). Converging pathogenic mechanisms in vascular and neurodegenerative dementia. Stroke 34:335-337.
6. Hachinski V and ladecola C (2004). Vascular cognitive impairment: introduction. Stroke 35:2615.
7. Bowler J V (2003). Acetylcholinesterase inhibitors for vascular dementia and Alzheimer's disease combined with cerebrovascular disease. Stroke 34:584-586.
8. Kalaria R N (2002). Small vessel disease and Alzheimer's dementia: pathological considerations. Cerebrovasc Dis 13:48-52.
9. Murray I V J, J F Proza, F Sohrabji and J M Lawler (2011). Vascular and metabolic dysfunction in Alzheimer's disease: a review. Exp. Biology & Medicine 236 (7): 772-782.
10. Bell R D and Zlokovic B V (2009). Neurovascular mechanisms and blood-brain barrier disorder in Alzheimer's disease. Acta Neuropathol. 118(1):103-13.
11. Nicolakakis N and Hamel E (2011). Neurovascular function in Alzheimer's disease patients and experimental models. J Cereb Blood Flow Metab. 31(6):1354-70.
12. Tong X K, Nicolakakis N, Kocharyan A, Hamel E (2005). Vascular remodeling versus amyloid beta-induced oxidative stress in the cerebrovascular dysfunctions associated with Alzheimer's disease. J Neurosci 25(48):11165-74.
13. Gorelick P B (2004). Risk factors for vascular dementia and Alzheimer disease. Stroke 35:2620-22.
14. Smith E E and S M Greenberg (2009). Amyloid-beta, blood vessels and brain function. Stroke 40 (7): 2601-2606.
15. Roher A E, Kuo Y M, Esh C, Knebel C, Weiss N, Kalbach W, Luehrs D C, Childress J L, Beach T G, Weller R O, Kokjohn T A (2003). Cortical and leptomeningeal cerebrovascular amyloid and white matter pathology in Alzheimer's disease. Mol Med 9:112-122.
16. Hardy J (2009). The amyloid hypothesis for Alzheimer's disease: a critical reappraisal. J. Neurochem. 110:1129-1134
17. Maeda H, Matsumoto M, Handa N, Hougaku H, Ogawa S, Itoh T, Tsukamoto Y, Kamada T. Reactivity of cerebral blood flow to carbon dioxide in various types of ischemic cerebrovascular disease: evaluation by the transcranial Doppler method. Stroke. 1993; 24:670-675.
18. Tantucci C, Bottini P, Fiorani C, Dottorini M L, Santeusanio F, Provinciali L, Sorbini C A, Casucci G. Cerebrovascular reactivity and hypercapnic respiratory drive in diabetic autonomic neuropathy. J Appl Physiol. 2001; 90:889-896.
19. Cupini L M, Diomedi M, Placidi F, Silvestrini M, Giacomini P. Cerebrovascular reactivity and subcortical infarctions. Arch Neurol. 2001; 58: 577-581.
20. Schneider J A, Wilson R S, Bienias J L, Evans D A and Bennett D A (2004). Cerebral infarctions and the likelihood of dementia from Alzheimer's disease pathology. Neurology 62:1148-1155.
21. Aaslid R, K F Lindegaard, W Sorteberg and H Nornes (1989). Cerebral autoregulation dynamics in humans. Stroke 20:45-52.
22. Czosnyka M, S Piechnik, H Richards, P Kirkpatrick, P Smielewski, and J Pickard (1997). Contribution of mathematical modeling to the interpretation of bedside tests of cerebrovascular autoregulation. J. Neurology, Neurosurgery & Psychiatry 63:721-731.
23. Czosnyka M, K Brady, M Reinhard, P Smielewski and L Steiner (2009). Monitoring of cerebrovascular autoregulation: facts, myths and missing links. Neurocrit. Care 10:373-386.
24. Giller C A (1990). The frequency-dependent behavior of cerebral autoregulation. Neurosurgery 27:362-368.
25. Giller C A and M Mueller (2003). Linearity and nonlinearity in cerebral hemodynamics. Med. Eng. Phys. 25:633-646.
26. Bellapart J and Fraser J F (2009). Transcranial Doppler assessment of cerebral autoregulation. Ultrasound in Medicine & Biology DOI: 10.1016/j.ultrasmedbio.
27. Panerai R B, S. L. Dawson, and J. F. Potter (1999). Linear and nonlinear analysis of human dynamic cerebral autoregulation. Am. J. Physiol. 277:H1089-H1099.
28. Panerai R B, D. M. Simpson, S. T. Deverson, P. Mahony, P. Hayes, and D. H. Evans (2000). Multivariate dynamic analysis of cerebral blood flow regulation in humans. IEEE Trans Biomed. Eng. 47:419-423.
29. Panerai R B (2008). Cerebral autoregulation: from models to clinical applications. Cardiovasc Eng 8:42-59.
30. Panerai R B (2009). Transcranial Doppler for evaluation of cerebral autoregulation. Clin Auton. Res. DOI 10.1007/s10286-009-0011-8.
31. Paulson O B, S Strandgaard and L Edvinsson (1990). Cerebral autoregulation. Cerebrovasc. Brain Metab. Rev. 2:161-192.
32. van Beek A H, J A Claassen, M G Rikkert and R W Jansen (2008). Cerebral autoregulation: overview of current concepts and methodology with special focus on the elderly. J Cereb Blood Flow Metab 28:1071-1085.
33. Zhang R, J H Zuckerman, C A Giller and B D Levine (1998). Transfer function analysis of dynamic cerebral autoregulation in humans. Am. J. Physiol. 274:233-241.
34. Zhang R, J. H Zuckerman, K Iwasaki, T E Wilson, C G Crandall and B D Levine (2002). Autonomic neural control of dynamic cerebral autoregulation in humans. Circulation 106:1814-1820.
35. Mitsis G D, R Zhang, B D Levine and V Z Marmarelis (2002). Modeling of nonlinear physiological systems with fast and slow dynamics II: Application to cerebral autoregulation. Ann. Biomed. Eng. 30:555-565.
36. Mitsis G D, R Zhang, B D Levine and V Z Marmarelis (2006). Cerebral hemodynamics during orthostatic stress assessed by nonlinear modeling. J. Appl. Physiol. 101:354-366.
37. Mitsis G D, R Zhang, B D Levine, E Tzanalaridou, D G Katritsis and V Z Marmarelis (2009). Nonlinear analysis of autonomic control of cerebral hemodynamics. IEEE Eng. in Medicine & Biology 28:54-62.
38. Mitsis G D, M J Poulin, P A Robbins and V Z Marmarelis (2004). Nonlinear modeling of the dynamic effects of arterial pressure and CO₂ variations on cerebral blood flow in healthy humans. IEEE Trans. on Biomedical Eng. 51:1932-1943.
39. van Beek A H, Lagro J, Olde-Rikkert M G, Zhang R, Claassen J A (2012). Oscillations in cerebral blood flow and cortical oxygenation in Alzheimer's disease. Neurobiol Aging. 33:428.e21-31.
40. Markus H S, Harrison M J (1992). Estimation of cerebrovascular reactivity using transcranial Doppler, including the use of breath-holding as the vasodilatory stimulus. Stroke 23:668-673.
41. Kiyoshi N, K Kazama, L Younkin, S G Younkin, G A Carlson and C ladecola (2002). Cerebrovascular autoregulation is profoundly impaired in mice overexpressing amyloid precursor protein. Am J Physiol Heart Circ Physiol 283:H315-H323.
42. Claassen J A, Diaz-Arrastia R, Martin-Cook K, Levine B D and Zhang R (2009). Altered cerebral hemodynamics in early Alzheimer disease: a pilot study using transcranial Doppler. J Alzheimers Dis. 17(3):621-629.
43. Claassen J A and R Zhang (2011). Cerebral autoregulation in Alzheimer's disease. J Cereb Blood Flow Metab. 31(7):1572-7.
44. Marmarelis V Z, D C Shin and R Zhang (2012). Linear and nonlinear modeling of cerebral flow autoregulation using Principal Dynamic Modes. Open Biomedical Eng. Journal 6:42-55.
45. Marmarelis V. Z., D. C. Shin, M. E. Orme, R. Diaz-Arrastia and R. Zhang. Model-based quantification of cerebral vasomotor reactivity and its use for improved diagnosis of Alzheimer's disease and MCI. Proc. 34th IEEE-EMBS Conf, Paper 431, San Diego, 2012,
46. Marmarelis V Z (2004). Nonlinear Dynamic Modeling of Physiological Systems. IEEE Press & Wiley-Interscience, New Jersey.

1. A method for computing a subject-specific index of CO2 vasomotor reactivity of cerebral hemodynamics comprising the steps of:
estimation of a subject-specific data-based dynamic nonlinear model of cerebral hemodynamics with two inputs (arterial blood pressure and end-tidal CO2) and one output (cerebral flow velocity);
computation of a model-based vasomotor reactivity index (VMRI) as a “physiomarker” that quantifies the CO2 vasomotor reactivity of a subject on the basis of the model-predicted cerebral flow velocity response to a positive and a negative pulse change of the CO2 input.

2. The method as set forth in claim 1, wherein the method further comprises the means for diagnosing and assessing the severity of Alzheimer's disease, mild cognitive impairment, and dementia, using the VMRI physiomarker.

3. The method as set forth in claim 1, wherein the method further comprises the means for assessing the cerebrovascular, neurovascular and neurological effects of hypertension, stroke, ischemia, subcortical infarctions, cerebral angiopathy and atrophy, and diabetes, using the VMRI physiomarker.

4. The method as set forth in claim 1, wherein the method further comprises the means for assessing the cerebrovascular, neurovascular and neurological effects of brain trauma and surgery, using the VMRI physiomarker.

5. The method as set forth in claim 1, wherein the method further comprises the means for assessing the effects of various medications on cerebrovascular, neurovascular and neurodegenerative diseases, as well as prescribing the proper dosage of such medications, using the VMRI physiomarker.

6. The method as set forth in claim 1, wherein the method further comprises the means for incorporating additional physiological variables in the model for the computation of the VMRI physiomarker that are measured by minimally-invasive and/or invasive procedures.

7. The method as set forth in claim 1, wherein the method further comprises the means for incorporating variables or parameters in the model for the computation of the VMRI that are measured at the molecular or cellular level.

8. A method for computing a subject-specific index of CO2 vasomotor reactivity of cerebral hemodynamics comprising the steps of:
estimation of a subject-specific data-based dynamic nonlinear model of cerebral hemodynamics with two inputs (arterial blood pressure and end-tidal CO2) and one output (cerebral flow velocity);
estimation of a subject-specific data-based dynamic nonlinear model of cerebral hemodynamics with two inputs (cerebral flow velocity and end-tidal CO2) and one output (arterial blood pressure);
computation of a model-based vasomotor reactivity index (VMRI) that quantifies the CO2 vasomotor reactivity of a subject on the basis of the model-predicted cerebral flow velocity response to a positive and negative pulse change of the CO2 in a closed-loop pressure-flow configuration that accounts for the mutual interdependence of blood pressure and cerebral flow.

9. The method as set forth in claim 8, wherein the method further comprises the means for incorporating additional physiological variables in the model, either in open-loop or closed-loop/nested-loop configurations utilizing feedback and cross-linking pathways that account for multiple physiological interactions, which influence cerebral hemodynamics and partake in the computation of the VMRI.

10. The method as set forth in claim 8, wherein the method further comprises the means for diagnosing and assessing the severity of Alzheimer's disease, mild cognitive impairment, and dementia, using the VMRI physiomarker.

11. The method as set forth in claim 8, wherein the method further comprises the means for assessing the cerebrovascular, neurovascular and neurological effects of hypertension, stroke, ischemia, subcortical infarctions, cerebral angiopathy and atrophy, and diabetes, using the VMRI physiomarker.

12. The method as set forth in claim 8, wherein the method further comprises the means for assessing the cerebrovascular, neurovascular and neurological effects of brain trauma and surgery, using the VMRI physiomarker.

13. The method as set forth in claim 8, wherein the method further comprises the means for assessing the effects of various medications on cerebrovascular, neurovascular and neurodegenerative diseases, as well as prescribing the proper dosage of such medications, using the VMRI physiomarker.

14. A method for computing a subject-specific index of CO2 vasomotor reactivity of cerebral hemodynamics comprising the steps of:
estimation of subject-specific data-based dynamic nonlinear models of cerebral hemodynamics with a plurality of inputs and outputs, which are measured physiological variables that affect cerebral hemodynamics;
computation of a model-based vasomotor reactivity index (VMRI) that quantifies the CO2 vasomotor reactivity of a subject on the basis of the model-predicted cerebral flow velocity response to a positive and negative pulse change of the CO2 in a nested-loop configuration that accounts for the mutual interdependences of all these variables.

15. The method as set forth in claim 14, wherein the method further comprises the means for incorporating additional physiological variables in the model for the computation of the VMRI physiomarker that are measured by non-invasive, minimally-invasive or invasive procedures.

16. The method as set forth in claim 14, wherein the method further comprises the means for incorporating variables or parameters in the model for the computation of the VMRI that are measured at the molecular or cellular level.

17. The method as set forth in claim 14, wherein the method further comprises the means for diagnosing and assessing the severity of Alzheimer's disease, Mild Cognitive Impairment, and dementia, using the VMRI physiomarker.

18. The method as set forth in claim 14, wherein the method further comprises the means for assessing the cerebrovascular, neurovascular and neurological effects of hypertension, stroke, ischemia, subcortical infarctions, cerebral angiopathy and atrophy, and diabetes, using the VMRI physiomarker.

19. The method as set forth in claim 14, wherein the method further comprises the means for assessing the cerebrovascular, neurovascular and neurological effects of brain trauma and surgery, using the VMRI physiomarker.

20. The method as set forth in claim 14, wherein the method further comprises the means for assessing the effects of various medications on cerebrovascular, neurovascular and neurodegenerative diseases, as well as prescribing the proper dosage of such medications, using the VMRI physiomarker.

21. The method as set forth in claim 14, wherein the method further comprises the means for incorporating additional physiological variables in the model for the computation of the VMRI physiomarker that are measured by non-invasive, minimally-invasive or invasive procedures.

22. The method as set forth in claim 14, wherein the method further comprises the means for incorporating variables or parameters in the model for the computation of the VMRI that are measured at the molecular or cellular level.
